(19) United States
(12) Patent Application Publication
(10) Pub. No.: US 2022/0225648 A1
(43) Pub. Date: Jul. 21, 2022

(54) FOOD COMPOSITIONS WITH MICROALGAL EXTRACTS

(71) Applicant: MARS, INCORPORATED, Mclean, VA (US)

(72) Inventors: Isabella VAN DAMME, Slough (GB); Keelan LAWLOR, Stirling (GB)

(21) Appl. No.: 17/579,385

(22) Filed: Jan. 19, 2022

Related U.S. Application Data
(60) Provisional application No. 63/138,850, filed on Jan. 19, 2021.

(51) Int. Cl. A23L 17/60; A23G 1/36

(52) U.S. Cl. CPC A23L 17/60; A23V 2002/00; A23G 1/36

(57) ABSTRACT

Provided herein are food compositions including a microalgal extract. In particular, provided herein are food compositions including a microalgal extract, wherein the microalgal extract includes a glycolipid in an amount of about 15 to 70 wt %, based on the total weight of the extract and, a phospholipid in an amount of about 5 to 70 wt %, based on the total weight of the extract. Further provided are methods of making the microalgal extract for use in food compositions.

### FIELD OF THE DISCLOSURE

The disclosure generally relates to food compositions including microalgal extracts. In particular, the disclosure generally relates to food compositions including microalgal extracts including a glycolipid and a phospholipid.

### BACKGROUND

Surfactants are often added to chocolate and other food products to help control rheological properties. For example, in chocolate, surfactants help reduce viscosity by adsorbing to the sugar, cocoa, milk particles (in milk chocolate), and possibly the butter crystals, in order to provide lubrication and promote dispersion of the particles in the continuous phase. Similarly, surfactants help reduce yield stress, help counter the effects of reduced cocoa butter content, and result in better viscosity stability, thereby reducing processing times and sensitivity to higher temperatures. Surfactants can also improve the appearance, texture and long-term storage stability of food product.

Lecithin and polyglycerol polyricinoleate (PGPR) are two common surfactants added to food products, such as chocolate. As a by-product of vegetable oil processing, lecithin is a complex mixture of polar lipids (phospholipids, glycolipids), neutral lipids (triacylglycerols) and other components such as carbohydrates and sterols. Lecithins are some of the most widely used surfactants. Although rapeseed and sunflower lecithins are often used, crude soy bean oil contains the highest quantities of polar lipids compared to these two sources of oil. However, there has been growing interest in non-soy lecithin in recent years in response to consumer demand as well as the complexities and difficulties sourcing certified non-GMO soy lecithin for the European market. This is evident in the increase in rapeseed lecithin use, despite an overall lower yield of lecithin being obtained from rapeseed oil (about half that achieved with soy).

PGPR is a semi-synthetic surfactant comprised of a mixture of polycondensed ester of polyglycerol polyricinoleic acid derived from vegetable (castor) oil. PGPR has a high molecular mass of 1200-2000 g/mol. It can be highly effective at reducing yield value with minimal or no effect on viscosity by reducing particle-particle interactions of the sucrose achieved by reducing the surface acidity overall increasing their lipophilicity. However, the use of PGPR is limited to 0.3% to 0.5% in chocolate formulations and, as a semi-synthetic surfactant, it is thought to have limited consumer acceptance when incorporated into food products.

Due to consumer demand for ‘natural’ ingredients, difficulty sourcing non-GMO lecithin, and sustainability concerns, there is a need to identify new sources and compounds for use in food compositions that have activities similar to lecithin and PGPR.

### SUMMARY

Provided herein are food compositions comprising a microalgal extract, wherein the microalgal extract comprises: a glycolipid in an amount of about 15 to 70 wt %, based on the total weight of the extract; and, a phospholipid in an amount of about 5 to 70 wt %, based on the total weight of the extract.

In various aspects, the microalgal extract is derived from a marine microalgae. In various aspects, the marine microalgae is selected from the group consisting of Chlorella, Phaeodactylum, Nannochloropsis, Cylindrotheca, Tetraselmis, Crysotila, and mixtures thereof. In various aspects, the marine microalgae comprises Phaeodactylum tricornutum, Nannochloropsis oceanica, Chlorella vulgaris, Cylindrotheca fusiformis, Tetraselmis suecica, Crysotila carterae, or a mixture thereof.

In various aspects, the microalgal extract comprises a glycolipid in an amount of about 15 to 30 wt %, based on the total weight of the extract; and, a phospholipid in an amount of about 10 to 20 wt %, based on the total weight of the extract.

In various aspects, the microalgal extract comprises a glycolipid in an amount of about 40 to 70 wt %, based on the total weight of the extract; and, a phospholipid in an amount of about 5 to 25 wt %, based on the total weight of the extract.

In various aspects, the microalgal extract comprises a glycolipid in an amount of about 20 to 45 wt %, based on the total weight of the extract; and, a phospholipid in an amount of about 40 to 70 wt %, based on the total weight of the extract.

In various aspects, the microalgal extract is present in an amount of about 0.05 wt % to 2.0 wt %, based on the total weight of the food composition.

In various aspects, the composition is substantially free of soy lecithin. In various aspects, the composition is substantially free of polyglycerol polyricinoleate (PGPR).

In various aspects, the composition exhibits a maximum yield stress of about 200 Pa. In various aspects, the composition exhibits a maximum high shear viscosity of about 50 Pa.

In various aspects, the microalgal extract comprises a glycolipid to phospholipid ratio ranging from about 1:3 to about 9:1.

In various aspects, the food composition is selected from the group consisting of a snack food product, a baby food, a pet food, an animal feed, a bakery product, a dairy product, a meal replacement product, a ready meal, a soup, a pasta, a noodle, a canned food, a frozen food, a dried food, a chilled food, an oil, a margarine, a fat, a spread, a confectionery, and mixtures thereof.

In various aspects, the food composition is a fat-based confectionery. In various aspects, the food composition is chocolate and further comprises at least one of cocoa solids, cocoa butter, sugar, milk powder, milk solids, and caramel.

In various aspects, the food composition is a non-fat-based confectionery. In various aspects, the non-fat-based confectionary is selected from the group consisting of a compressed mint, a cotton candy, a frozen confection, a liquorice, a chewing gum, a gelled candy, a tableted candy, a hard candy, a chewy candy, and a combination thereof.

In various aspects, the food composition is a confectionery selected from the group consisting of chocolate, cotton candy, pudding, fudge, toffee, gum, gelled candy, tableted candy, hard candy, chewy candy, and a combination thereof.

Further provided herein are methods of preparing a microalgal extract for use in a food composition, comprising: admixing a microalgae with an aqueous solution to provide a microalgal extraction mixture; extracting a lipid-rich extract from the microalgal extraction mixture; and, adding the lipid-rich extract to the food composition.

Further provided herein are methods of preparing a microalgal extract for use in a food composition, comprising: admixing a microalgae with an aqueous solution to provide a microalgal extraction mixture; extracting a lipid-rich extract from the microalgal extraction mixture; fractionating the lipid-rich extract to provide a glycolipid-rich extract and/or a phospholipid-rich extract; and adding the glycolipid-rich extract and/or the phospholipid-rich extract to the food composition.

In various aspects, the aqueous solution comprises an aqueous salt solution and methanol. In various aspects, the aqueous salt solution comprises KCl.

In various aspects, the glycolipid-rich extract is added to the food composition. In various aspects, the phospholipid-rich extract is added to the food composition.

Further aspects of the disclosure may become apparent to those skilled in the art from a review of the following detailed description, taken in conjunction with the examples and appended claims. While the invention is susceptible to embodiments in various forms, described herein are specific embodiments of the invention with the understanding that the disclosure is illustrative, and is not intended to limit the invention to specific embodiments described herein. For example, where features are described with language such as “one aspect,” “some aspects,” “various aspects,” etc. each of these types of embodiments is a non-limiting example of a feature that is intended to be combined with any other feature, or combination of features, described herein without having to list every possible combination. Such features or combinations of features apply to any of the aspects of the invention.

The headings herein are for the convenience of the reader and not intended to be limiting. Additional aspects, embodiments, and variations of the invention will be apparent from the Detailed Description and/or drawings and/or claims.

### BRIEF DESCRIPTION OF THE DRAWINGS

FIG. 1 is a graph of the total lipid content extracted from each of the microalgae species tested in Example 2, based on the total dry weight of the sample.

FIG. 2 is a graph of the amounts of lipid in each of the four fractions referenced in Example 2 after solid phase extraction (SPE) fractionation of each microalgae species, based on the total lipid content.

FIG. 3 is a graph of the amount of each lipid class in the total lipid extract (CH TLE) and in each of the four fractions (FR1-4) after SPE fractionation of C. fusiformis CCAP 1017/2.

FIG. 4 is a graph of the amount of each lipid class in the total lipid extract (CH TLE) and in each of the four fractions (FR1-4) after SPE fractionation of T. suecica CCAP 66/38_1.

FIG. 5 is a graph of the amount of each lipid class in the total lipid extract (CH TLE) and in each of the four fractions (FR1-4) after SPE fractionation of P. tricornutum CCAP 1055/15.

FIG. 6 is a graph of the amount of each lipid class in the total lipid extract (CH TLE) and in each of the four fractions (FR1-4) after SPE fractionation of N. oceanica CCAP 849/10.

FIG. 7 is a graph of the amount of each lipid class in the total lipid extract (CH TLE) and in each of the four fractions (FR1-4) after SPE fractionation of C. vulgaris CCAP 211/21A.

FIG. 8 is a graph of the amount of each lipid class in the total lipid extract (CH TLE) and in each of the four fractions (FR1-4) after SPE fractionation of C. carterae CCAP 961/1. As indicated by ** in FIG. 8, the phospholipid includes betaine.

### DETAILED DESCRIPTION

The disclosure provides food compositions including a microalgal extract. The microalgal extract can be added to food compositions, such as chocolate, as a full or partial replacement of surfactants, such as lecithin and PGPR. As the microalgal extracts are naturally and sustainably sourced and processed, the food compositions described herein can advantageously maintain the functional characteristics of the food product while simultaneously meeting consumer demands.

### Microalgal Extract

As described herein, the food compositions include a microalgal extract. As used herein, the term “microalgal extract,” refers to a fraction or substance that is isolated from microalgae. For example, a microalgae can be collected, cultured under various conditions, and then treated to isolate or purify a microalgal extract that is, for example, rich in lipids such as glycolipid and/or phospholipid. The amount and proportions of these lipids in the microalgal extract are not necessarily the same as those of the same lipids in the microalgae as it exists in nature.

In various aspects, the microalgae is a marine microalgae. Representative examples of marine microalgae suitable for use in the context of the disclosure include, but are not limited to, microalgae of the Chlorella, Phaeodactylum, Nannochloropsis, Cylindrotheca, Tetraselmis, Isochrysis, Skeletonema, Thalassiosira, Emiliania, Odontella, Heterosigma, or Crysotila genera. In some aspects, the marine microalgae is selected from Chlorella, Phaeodactylum, Nannochloropsis, Cylindrotheca, Tetraselmis, Crysotila, or a mixture thereof. Examples of suitable marine microalgae include, but are not limited to, Phaeodactylum tricornutum, Nannochloropsis oceanica, Chlorella vulgaris, Cylindrotheca fusiformis, Tetraselmis suecica, Tetraselmis chui, Isochrysis galbana, Skeletonoema costatum, Thalassiosira pseudonana, Thalassiosira weissflogii, Emiliania huxleyi, Odontella aurita, Crysotila carterae, and the like. In various aspects, the marine microalgae is Phaeodactylum tricornutum, Nannochloropsis oceanica, Chlorella vulgaris, Cylindrotheca fusiformis, Tetraselmis suecica, Crysotila carterae, or a mixture thereof. Optionally, the microalgal extract is isolated from a single type of microalgae (i.e., a substantially pure culture or population of a particular microalgae). Alternatively, the microalgal extract optionally includes a mixture of extracts derived from (i.e., isolated from) two or more different types of microalgae (i.e., a mixed population or culture of microalgae strains).

In various aspects, the microalgal extract of the disclosure includes a glycolipid and a phospholipid.

Phospholipids have amphiphilic properties and are the main substances forming cell membranes. Lecithin comprises a mix of phospholipids, such as phosphatidylcholine (PC), phosphatidylethanolamine (PE), phosphatidylinositol (PI), and phosphatidic acid (PA), with minor amounts of lyso-phosphatidylcholine (LPC).

Glycolipids are low molecular surfactants, examples of which include, for example, rhamnolipids, sophorolipids, trehalolipids, and mannosylerythritol lipids (MELs). Each of rhamnolipids, sophorolipids, trehalolipids, and MELs are bacterial glycolipids which are associated with high cost.

The amount of glycolipid and phospholipid in the microalgal extract can play a role in the functional properties that the microalgal extract imparts on the food composition. For example, the microalgal extract can include a glycolipid in an amount of at least about 15, 20, 25, 30, 35, 40, 45, or 50 wt % and/or up to about 70, 65, 60, 55, 50, 45, 40, or 35 wt %, based on the total weight of the extract. For example, the microalgal extract can include a glycolipid in an amount of about 15, 20, 25, 30, 35, 40, 45, 50, 55, 60, 65, or 70 wt %, based on the total weight of the extract. The microalgal extract can include a phospholipid in an amount of at least about 5, 10, 15, 20, 25, 30, 35, 40, or 45 wt % and/or up to about 70, 65, 60, 55, 50, 45, 40, 35, 30, 25, or 20 wt %, based on the total weight of the extract. For example, the microalgal extract can include a phospholipid in an amount of about 5, 10, 15, 20, 25, 30, 35, 40, 45, 50, 55, 60, 65, or 70 wt %, based on the total weight of the extract. For example, in various aspects of the disclosure, the microalgal extract includes a glycolipid in an amount of about 15 wt % to about 70 wt %, based on the total weight of the extract, and a phospholipid in an amount of about 5 wt % to about 70 wt %, based on the total weight of the extract.

In various aspects, the microalgal extract can be a “lipid-rich” microalgal extract. As used herein, the term “lipid-rich” means that the extract includes at least about 40 wt % lipid, based on the total weight of the extract. The lipid in the lipid-rich extract can include each of glycolipid and/or phospholipid, as well as other neutral lipids. For example, the microalgal extract, e.g., a lipid-rich microalgal extract, can include a glycolipid in an amount of at least about 15, 20, or 25 wt % and/or up to about 30, 25, or 20 wt %, based on the total weight of the extract. For example, the microalgal extract can include a glycolipid in an amount of about 15, 20, 25, or 30 wt %, based on the total weight of the extract. The microalgal extract, e.g., a lipid-rich microalgal extract, can include a phospholipid in an amount of at least about 10, 12, 15, or 17 wt % and/or up to about 20, 17, 15, or 12 wt %, based on the total weight of the extract. For example, the microalgal extract can include a phospholipid in an amount of about 10, 12, 15, 17, or 20 wt %, based on the total weight of the extract. In various aspects, the microalgal extract, e.g., a lipid-rich microalgal extract, includes a glycolipid in an amount of about 15 wt % to about 30 wt %, based on the total weight of the extract, and a phospholipid in an amount of about 10 wt % to about 20 wt %, based on the total weight of the extract.

In various aspects, the microalgal extract can be a glycolipid-rich microalgal extract. As used herein, the term “glycolipid-rich” means that the microalgal extract includes at least about 40 wt % glycolipid, based on the total weight of the extract. For example, the microalgal extract, e.g., a glycolipid-rich microalgal extract, can include a glycolipid in an amount of at least about 40, 45, 50, 55, or 60 wt % and/or up to about 70, 65, 60, 55, or 50 wt %, based on the total weight of the extract. For example, the microalgal extract can include a glycolipid in an amount of about 40, 45, 50, 55, 60, 65, or 70 wt %, based on the total weight of the extract. The microalgal extract, e.g., a glycolipid-rich microalgal extract, can include a phospholipid in an amount of at least about 5, 10, 15, or 20 wt % and/or up to about 25, 20, 15, or 10 wt %, based on the total weight of the extract. For example, the microalgal extract can include a phospholipid in an amount of about 5, 10, 15, 20, or 25 wt %, based on the total weight of the extract. In various aspects, the microalgal extract, e.g. a glycolipid-rich microalgal extract, includes a glycolipid in an amount of about 40 wt % to about 70 wt %, based on the total weight of the extract, and a phospholipid in an amount of about 5 wt % to about 25 wt %, based on the total weight of the extract.

In various aspects, the microalgal extract can be a phospholipid-rich microalgal extract. As used herein, the term “phospholipid-rich” means that the microalgal extract includes at least about 40 wt % phospholipid, based on the total weight of the extract. For example, the microalgal extract, e.g., a phospholipid-rich microalgal extract, can include a glycolipid in an amount of at least about 20, 25, 30, 35, or 40 wt % and/or up to about 45, 40, 35, 30 or 25 wt %, based on the total weight of the extract. For example, the microalgal extract can include a glycolipid in an amount of about 20, 25, 30, 35, 40, or 45 wt %, based on the total weight of the extract. The microalgal extract, e.g., a phospholipid-rich microalgal extract, can include a phospholipid in an amount of at least about 40, 45, 50, 55, 60, or 65 wt % and/or up to about 70, 65, 60, 55, 50, or 45 wt %, based on the total weight of the extract. For example, the microalgal extract can include a phospholipid in an amount of about 40, 45, 50, 55, 60, 65, or 70 wt %, based on the total weight of the extract. In various aspects, the microalgal extract, e.g., a phospholipid-rich extract, comprises a glycolipid in an amount of about 20 wt % to about 45 wt %, based on the total weight of the extract, and a phospholipid in an amount of about 40 wt % to about 70 wt %, based on the total weight of the extract.

The microalgal extract can include a glycolipid and a phospholipid in a glycolipid-to-phospholipid (GLY:PL) ratio of about 1:3 to about 9:1. For example, in various aspects, the GLY:PL ratio is about 1:3, 1:2, 1:1.5, 1:1, 1.5:1, 2:1, 3:1, 4:1, 5:1, 6:1, 7:1, 8:1, or 9:1.

The microalgal extract can include components other than glycolipid and phospholipid, for example, neutral lipids (e.g., triacylglycerol (TAG)), fatty acids, sterols, pigments, nitrogenous compounds, vitamins, carotenoids, phycocyanin, and the like. When present, fatty acids can include, for example, polyunsaturated fatty acids (PUFA), mono-unsaturated fatty acids (MUFA), saturated fatty acids, free fatty acids (FFA), fatty acid methyl esters (FAME), omega-6 fatty acids, omega 3-fatty acids, and mixtures thereof. For example, the microalgal extract can include at least about 1, 2, 3, 4, 5, 10, 15, 20, 25, or 30 wt % fatty acids, based on the total weight of the extract and/or up to about 55, 50, 45, 40, 35, 30, 25, or 20 wt % fatty acids, based on the total weight of the extract.

### Food Composition

As described herein, the microalgal extract is included in a food composition. The microalgal extract can be present in the food composition in an amount of at least about 0.05, 0.1, 0.15, 0.2, 0.25, 0.3, 0.45, 0.5, 0.55, 0.6, or 0.65 wt % and/or up to about 2.0, 1.5, 1.0, 0.95, 0.9, 0.85, 0.8, 0.75, 0.7, 0.65, 0.6, 0.55, or 0.5 wt %, based on the total weight of the food composition. In various aspects, the microalgal extract is included in an amount of about 0.2 wt %, based on the total weight of the food composition, wherein the food composition is optionally a confection, such as chocolate. In various aspects, the microalgal extract is included in an amount of about 0.82 wt %, based on the total weight of the food composition, wherein the food composition is optionally a confection, such as chocolate.

Advantageously, the microalgal extract can serve as a partial or full replacement of surfactants in the food composition, such as a full or partial replacement of lecithin (e.g., soy lecithin (SL)) and/or polyglycerol polyricinoleate (PGPR). In various aspects, the composition is substantially free of lecithin, such as soy lecithin. In various aspects, the composition is substantially free of PGPR. As used herein, “substantially free of” means that the food composition does not include intentionally added lecithin or PGPR. Residual or otherwise minor amounts of lecithin and PGPR may be present in the food composition. Alternatively, the lecithin or PGPR may be present, for example in an amount of less than about 5, 4, 3, 2, 1, 0.5, 0.1, 0.01 wt %, based on the total weight of the food composition. Trace amounts may be present by nature of the inclusion of other components of the food composition that may include minor amounts of lecithin or PGPR.

As a partial or full replacement to the surfactants of the food composition, the microalgal extract can impart functional properties, e.g., rheology modification, emulsification, stabilization, and the like, to the food composition. In various aspects, the food composition exhibits a maximum yield stress (YS) of about 2000 Pa. Some products without a yield stress may also be positively impacted by the inclusion of the microalgal extract of the disclosure. In various aspects, the food composition exhibits a maximum yield stress of 200 Pa. For example, in various aspects, the food composition exhibits a yield stress of at least about 1, 2, 3, 4, 5, 10, 15, 20, 25, 30, 35, 40, 45, or 50 Pa and/or up to about 200, 175, 150, 125 100, 95, 90, 85, 80, 75, 70, 65, 60, 55, or 50 Pa. In various aspects, the food composition is a fat-based confectionary composition and exhibits a yield stress of about 0 Pa to about 200 Pa. In a preferred aspect, the fat-based confectionary exhibits a yield stress of less than about 50 Pa. In an aspect, the fat-based confectionary exhibits negligible yield stress.

In various aspects, the food composition exhibits a maximum high shear viscosity (HSV) of about 50 Pa. For example, in various aspects, the food composition exhibits a yield stress of at least about 1, 2, 3, 4, 5, 10, 15, 20, 25, 30, 35 or 40 Pa and/or up to about 50, 45, 40, 35, 30, 25, 20, 19, 18, 17, 16, 15, 14, 13, 12, 11, or 10 Pa.

The food composition described herein is not particularly limited, and can include, for example, snack food products, baby foods, pet food, animal feed, bakery products, dairy products, meal replacement products, ready meals, soups, pastas, noodles, canned foods, frozen foods, dried foods, chilled foods, oils, margarines, fats, spreads, confectionery, or mixtures thereof.

In various aspects, the food composition is a snack food product. As used herein, the term “snack food product” refers to a sweet or savory food product, such as fruit snacks, chips/crisps, extruded snacks, tortilla/corn chips, popcorn, pretzels, nuts, granola/muesli bars, breakfast bars, energy bars, fruit bars, and other snack bars. A snack food product may contain combinations of any of the foregoing, e.g., a pretzel and nut mix. Optionally, the food composition is a fruit snack, chips/crisps, pretzels, nuts, granola/muesli bar, breakfast bar, energy bar, fruit bar, or other snack bar. In various aspects, the food composition is a chocolate-coated food product.

In various aspects, the food composition is a baby food. Examples of baby food include, but are not limited to, prepared baby food, dried baby food, milk formula, standard milk formula, follow-on milk formula, toddler milk formula, and hypoallergenic milk formula.

In various aspects, the food composition is a bakery product, such as a muffin, bagel, cookie, brownie, pastry, and the like.

In various aspects, the food composition is a frozen food. Frozen foods refer to chilled or frozen food products, which include, but are not limited to ice cream, impulse ice cream, single portion dairy ice cream, single portion water ice cream, multi-pack dairy ice cream, multi-pack water ice cream, take-home ice cream, take-home dairy ice cream, ice cream desserts, bulk ice cream, take-home water ice cream, frozen yoghurt, artisanal ice cream, frozen ready meals, frozen pizza, chilled pizza, frozen soup, frozen pasta, frozen processed red meat, frozen processed poultry, frozen processed fish/seafood, frozen vegetables, frozen processed vegetables, frozen meat substitutes, frozen potatoes, frozen bakery products and frozen desserts.

In various aspects, the food composition is a pet food or animal feed. As used herein, the terms “pet” and “animal” are used interchangeably to refer to domestic animals including, but not limited to, domestic dogs, domestic cats, horses, cows, ferrets, rabbits, pigs, rats, mice, gerbils, hamsters, goats, and the like. Domestic dogs and cats are particular non-limiting examples of pets. The term “pet” or “animal” as used in accordance with the present disclosure can further refer to wild animals, including, but not limited to bison, elk, deer, venison, duck, fowl, fish, and the like.

As used herein, the term “pet food” or “pet food composition” means a composition intended for ingestion by a pet. Pet foods may include, without limitation, nutritionally balanced compositions suitable for daily feed, such as dry pet food (e.g., kibbles), semi-moist pet food, or wet pet food, as well as supplements and/or treats, which may or may not be nutritionally balanced. As used herein, the term “nutritionally balanced” means that the composition, such as pet food, has known required nutrients to sustain life in proper amounts and proportion based on recommendations of recognized authorities, including governmental agencies, such as, but not limited to, Unites States Food and Drug Administration's Center for Veterinarian Medicine, the American Feed Control Officials Incorporated, in the field of pet nutrition, except for the additional need for water. In various aspects, the pet food is a supplement and/or treat and the supplement and/or treat is a chew or a multi-component food.

The food composition is or can include a confectionery. For example, the food composition is, in various aspects of the disclosure, a confectionery selected from the group consisting of chocolate, frozen confections, compressed mints, cotton candy, pudding, fudge, fondant, liquorice, toffee, chewing gum, gelled candy, tableted candy, hard candy, and chewy candy. In various aspects, the food composition is a fat-based confectionery, such as chocolate, pudding, fudge, and the like. As used herein, the term “chocolate” refers to a solid or semi-plastic food and is intended to refer to all chocolate or chocolate-like compositions containing a fat-based component phase or fat-like composition, e.g., fudge, pudding. The term is intended to include standardized or nonstandardized compositions conforming to the U.S. Standards Of Identity (SOI), CODEX Alimentarius and/or other international standards and compositions not conforming to the U.S. Standards Of Identity or other international standards. The term includes dark chocolate, baking chocolate, sweet chocolate, bittersweet or semisweet chocolate, milk chocolate, buttermilk chocolate, skim milk chocolate, mixed dairy product chocolate, white chocolate, sweet cocoa and vegetable fat coating, sweet chocolate and vegetable fat coating, milk chocolate and vegetable fat coating, vegetable fat based coating, pastels including white chocolate or coating made with cocoa butter or vegetable fat or a combination of these, nutritionally modified chocolate-like compositions (chocolates or coatings made with reduced calorie ingredients) and low fat chocolates, aerated chocolates, compound coatings, non-standardized chocolates and chocolate-like compositions, unless specifically identified otherwise. In various aspects, the food composition comprises at least one of cocoa solids, cocoa butter, sugar, artificial sweetener, milk powder, milk solids, and caramel.

Nonstandardized chocolates are those chocolates which have compositions that fall outside the specified ranges of the standardized chocolates. For example, nonstandardized chocolates result when, for example, the nutritive carbohydrate sweetener is replaced partially or completely; or when the cocoa butter, cocoa butter alternative, cocoa butter equivalent, cocoa butter extender, cocoa butter replacer, cocoa butter substitute or milk fat are replaced partially or completely; or when components that have flavors that imitate milk, butter or chocolate are added or other additions or deletions in formula are made outside the FDA standards of identify of chocolate or combinations thereof. Chocolate-like compositions are those fat-based compositions that can be used as substitutes for chocolate in applications such as panning, molding, or enrobing. An example of a chocolate-like composition is carob.

Chocolate can contain bulking agents. Examples of bulking agents include, e.g., polydextrose, cellulose and its derivatives, maltodextrin, gum arabic, and the like.

In various aspects, the food composition is a non-fat-based confectionery. Non-fat-based confectioneries include, for example, candies other than chocolate, such as compressed mints, cotton candy, frozen confections, liquorice, chewing gum, gelled candy, tableted candy, hard candy, and chewy candy.

Gelled candy (i.e., gelled confections) are sometimes called gummies, jellies, or gum drops. Gelled confections can be transparent, translucent, or opaque. Gelled confections are often chewed as they have a firm, elastic texture that appeals to consumers. As gelled confections are chewed, they break apart into smaller pieces, which then dissolve in the mouth. These smaller confection pieces dissolve slowly in the mouth and deliver flavor and sweetness as they dissolve into a pleasant syrup during chewing. Gelled confections may contain, for example, gelling agents, bulking sweetener agent, doctoring agent, flavors, actives, colors, sensates, and/or high intensity sweeteners.

Hard candy is sometimes called boiled, glass, amorphous, or rock candy. Typical forms of hard candy are lollipops and lozenges. Hard candy can be transparent, translucent, or opaque. These confectionary products dissolve slowly in the mouth and deliver flavor and sweetness as they dissolve. They also crunch when chewed; that is, they give an audible sound as they break into smaller pieces when chewed. By “hard”, it is meant that the candy is firm, non-flexible, and non-deforming at room temperature (e.g., 25° C.). The hard mass can contain some crystalline material, though crystalline material reduces candy clarity and the preferred hard candy is translucent or transparent. To be commercially acceptable, the hard candy needs to have a non-sticky surface and stable shape, both upon cooling to room temperature and after a reasonable storage at a reasonable relative humidity; that is, the hard candy must be at least as stable as sucrose: corn syrup hard candy at an 80:20 dry solids wt. % ratio.

Tableted candy is enjoyed by consumers, as they can be dissolved slowly in the mouth or crunched giving an audible sound. Tableted candies usually have a strong flavor that releases slowly and are typically used to freshen breath. Tableted candy is a food product that is generally formed by blending powders comprising bulking agents, sweetening agents, binding agents and excipients and flavors. These ingredients are generally blended together as powders and fed into a typical tableting machine to make the finished piece.

The food composition can be prepared without the addition of refined sugar or artificial sweetener. However, in some aspects, the food composition further comprises one or more optional additives that are selected from an enzyme, an acidulant, a nutritional supplement, a sweetener, a divalent metal ion, an antioxidant, a coloring, a flavoring and/or combinations thereof.

The final product is a food composition suitable for packaging in single or multiple serving sizes.

In various aspects wherein the food composition is intended for human consumption, all ingredients, additives and other additions to any composition or used in any method are generally regarded as safe (GRAS) as designated by the United States FDA or FEMA GRAS as designated by the International Flavor and Manufacturing Association.

In various aspects, the food composition can be 100% organic as defined by the US Department of Agriculture, the European Commission or appropriate certifying organization. The products are preferably substantially or completely free of artificial food additives. In various aspects, the food composition is 100% all natural ingredients.

### Methods of Preparing Microalgal Extract for Use in Food Compositions

The disclosure further provides methods of preparing a microalgal extract for use in a food composition. As described herein, the microalgal extract can include a lipid-rich extract of the microalgae, a glycolipid-rich extract of the microalgae, or a phospholipid-rich extract of the microalgae.

The microalgae, e.g., marine microalgae, used to prepare the microalgal extract of the disclosure can be obtained and cultivated in accordance with a number of methods known to those skilled in the art. For example, when planning a microalgae cultivation strategy there are a number of considerations, such as metabolic growth mode (e.g., photoautotrophic, heterotrophic, or mixotrophic) nutrient requirement, culture vessel selection (e.g., photobioreactor, pond etc.), light source (if needed), cultivation mode (i.e. batch, semicontinuous or continuous) and appropriate processing methods for harvesting and dewatering the biomass. Upon obtaining and cultivating the microalgae, a powdered microalgae can optionally be prepared, for example, by lyophilizing the microalgae.

The methods of the disclosure include admixing a microalgae, such as a marine microalgae described herein, with an aqueous solution to provide a microalgal extraction mixture. In various aspects, the aqueous solution includes an aqueous salt solution and methanol. The aqueous salt solution can comprise, for example, NaCl, KCl, or CaCl₂. In addition to water, the aqueous solution can further include additional solvents such as chloroform, methanol, and isopropanol. In various aspects, the additional solvent can be heated to a temperature of about 50° C., 60° C., 70° C., or 80° C. prior to addition to the microalgae. For example, in various aspects, isopropanol can be heated to a temperature of about 70° C. prior to mixing with the microalgae. In various aspects, the microalgal extraction mixture is cooled prior to extraction, for example, by placing in an ice bath for at least about 30 minutes. In various aspects, the microalgal extraction mixture is centrifuged or homogenized prior to extraction. Examples of suitable extraction methods include Folch Extraction (FE) and Bligh and Dyer Extraction (BDE).

The methods further include extracting a lipid-rich extract from the microalgal extraction mixture. The lipid-rich extract can be extracted or separated from the microalgal extraction mixture according to methods known in the art, such as by use of a separating funnel or filters. The lipid-rich extract can optionally be dried and/or stored (e.g. in a desiccator) until further use, which can include, for example, addition to a food composition as a partial or full replacement of surfactants such as lecithin and/or PGPR.

The methods can further include fractionating the lipid-rich extract to provide a glycolipid-rich extract and/or a phospholipid-rich extract. The lipid-rich extract can be fractionated according to methods known in the art, such as by use of silica solid phase extraction (SPE). In various aspects, a vacuum manifold can be used to accelerate the fractionation process. Fractionating the lipid-rich extract via silica SPE can include the use of various mobile phases including isohexane, diethyl ether, methanol, chloroform, water, and mixtures thereof. In various aspects, the mobile phase includes an 8:2 v/v isohexane:diethyl ether solution. In various aspects, the mobile phase includes a 1:1 v/v isohexane:diethyl ether solution. In various aspects, the mobile phase includes methanol. In various aspects, the mobile phase includes a 50:50 mix of methanol and a 3:5:2 v/v chloroform:methanol:water solution. More than one mobile phase can be used, depending on the number of fractions present in the lipid-rich extract. In various aspects, the lipid-rich extract can be fractionated into a glycolipid-rich extract. In various aspects, the lipid-rich extract can be fractionated into a phospholipid-rich extract. Each of the glycolipid-rich extract and/or phospholipid-rich extract can optionally be dried and/or stored until further use, which can include, for example, addition to a food composition as a partial or full replacement of surfactants such as lecithin and/or PGPR.

The methods of the disclosure further include adding the lipid-rich extract, the glycolipid-rich extract, and/or the phospholipid-rich extract to a food composition. The lipid-rich extract, the glycolipid-rich extract, and/or the phospholipid-rich extract can be added to any of the food compositions described herein. Methods of adding the lipid-rich extract, the glycolipid-rich extract, and/or the phospholipid-rich extract to the food composition are generally known in the art, and can include those methods that are used to add surfactants, such as soy lecithin and PGPR to food products.

It is understood that while the disclosure is read in conjunction with the detailed description thereof, the foregoing description and following examples are intended to illustrate and not limit the scope of the disclosure, which is defined by the scope of the appended claims. Other aspects, advantages, and modifications are within the scope of the following claims.

### EXAMPLES

### Example 1: Cultivation and Preparation of Powdered Microalgae

Cultures of Cylindrotheca fusiformis CCAP 1017/2, Tetraselmis suecica CCAP 66/38_1, Phaeodactylum tricornutum CCAP 1055/15, Nannochloropsis oceanica CCAP 849/10, Chlorella vulgaris CCAP 211/21A, and Crysotila carterae CCAP 961/1 were obtained from the Culture Collection of Algae and Protozoa (CCAP, UK). T. suecica, N. oceanica, C. vulgaris, C. carterae were cultured in Guillards F/2 medium (Guillard, 1975). C. fusiformis and P. tricornutum were cultured in Guillards F/2+Si. All species were cultivated in 150 ml of media in 500 mL Erlenmyer flasks at 16 h:8 h Light:Dark at 20° C.

Species were grown to early stationary phase before being used to inoculate [10% (v/v) inoculum] 200 ml of sterile medium. Cells were enumerated by taking an aliquot of culture, diluting appropriately with fresh sterile media (f/2 or f/2+Si for diatoms) and counted using an improved Neubauer haemocytometer. Each culture was then used to inoculate 2 L culture vessels, which were incubated in 150 ml of media at 16 h:8 h Light:Dark at 20° C., but with addition of filtered (0.45 μm) air providing mixing and gaseous exchange in the cultures. Once the cultures reached stationary phase these were used to inoculate a carboy containing 20 L of sterile medium. Carboys were incubated as described above.

Once the culture had reached late stationary phase, which was determined by cell counts, 18 L of the culture was harvested by centrifugation (13,000 g for 10 minutes) to produce a cell pellet. This was transferred to a single 50 ml falcon tube and stored at −20° C. in the dark. An aliquot of fresh sterile medium (20 L) was then transferred to the carboy containing the remaining 2 L of stationary phase culture and the carboy was then incubated under the same conditions. This semi-continuous harvesting method was repeated for each of the species tested for 10 total harvests.

All cell pellets were lyophilized while being protected from light until dry. The cell pellets were then powdered using a mortar and pestle and the powder was stored in the dark in a sealed falcon tube under oxygen free nitrogen (OFN) at −80° C. prior to use.

### Example 2: Extraction and Fractionation

The microalgae powder from each of the 10 harvests of Example 1 were pooled to produce one pool per species of microalgae. These pools were then subdivided into 5 g batches for extraction. Each batch was hydrated with 10 ml of 0.88% (w/v) KCl in deionized water before addition of 150 ml of methanol and mixing. Then 75 ml of chloroform and 67.5 ml KCl solution were added before storing for 1 hour at −20° C. with vigorous mixing every 15 minutes. The extraction mixture was then decanted into a 500 ml glass separating funnel before the second addition of 75 ml of chloroform and 67.5 ml KCl solution. The sample was mixed, flushed with oxygen free nitrogen (OFN) and allowed to separate overnight at room temperature (RT). The bottom phase (containing lipids) was then removed, filtered, and dried under OFN.

As the interface layer for all species did not consolidate tightly, achieved previously by centrifugation, the interface was processed to obtain residual lipids. Briefly, the aqueous top portion was removed, and the remaining interface decanted into tubes. Separation of lipid extract from interface material was achieved by centrifugation. Additional lipid extract recovered this way was filtered and added to the lipid extract from previous step. Once all of the 5 g batches were complete for each species, the total lipid extract (TLE) from each batch were re-suspended in chloroform:methanol (2:1 v/v), pooled to form one TLE pool per species and stored at −20° C. under OFN.

A portion of each of the TLE pools were dried under OFN to constant mass and were fractionated by silica solid phase extraction (SPE). In particular, after equilibrating a 10 g column by flushing through with isohexane (min. 2× column volumes), approx. 1 g of dried TLE was re-suspended in the minimum amount of mobile phase (MP) 1 (usually 1-1.5 ml) which was then subtracted from the total MP to be applied to the column. The TLE was applied to the column and allowed to move onto the silica before flushing through with the mobile phases as detailed in Table 1 below.

TABLE 1
Mobile Phases Used for Fractionation

| Fraction No. | Mobile phase | Volume used (ml) |
|---|---|---|
| 1 | Isohexane:diethyl ether (8:2 v/v) | 60 |
| 2 | Isohexane:diethyl ether (1:1 v/v) | |
| 3 | Methanol | |
| 4 | 50:50 mix of methanol and | |
| | chloroform:methanol:water (3:5:2 v/v) | |

A number of SPE operations were required to process all the TLE from each microalgae species. Fractions were dried to constant mass under OFN. These were placed in a vacuum desiccator (protected from light) overnight to ensure all solvent residues had been removed and yields determined gravimetrically. A portion of each fraction (for lipid class and fatty acid analysis) was re-suspended in chloroform:methanol+BHT (0.01% w/v) at 10 mg/ml, transferred to glass vials, flushed with OFN and stored at −20° C. The remainder of the extracts were then pooled according to fraction number and species to obtain the final four samples of fractionated lipid for incorporation into chocolate test mixes.

The lipid extracts from each extraction were analysed for lipid class by HPTLC using a single dimension, double development system and lipid classes quantified by image analysis. Total lipid fatty acids were transesterified to fatty acid methyl esters (FAMEs). FAMEs were identified by GC-FID (Shimadzu GC-2014) and identification was confirmed by GC-MS (ThermoFisher). Position of double bonds was confirmed by GC-MS of 4,4-dimethyloxazoline (DMOX) derivatives.

Results

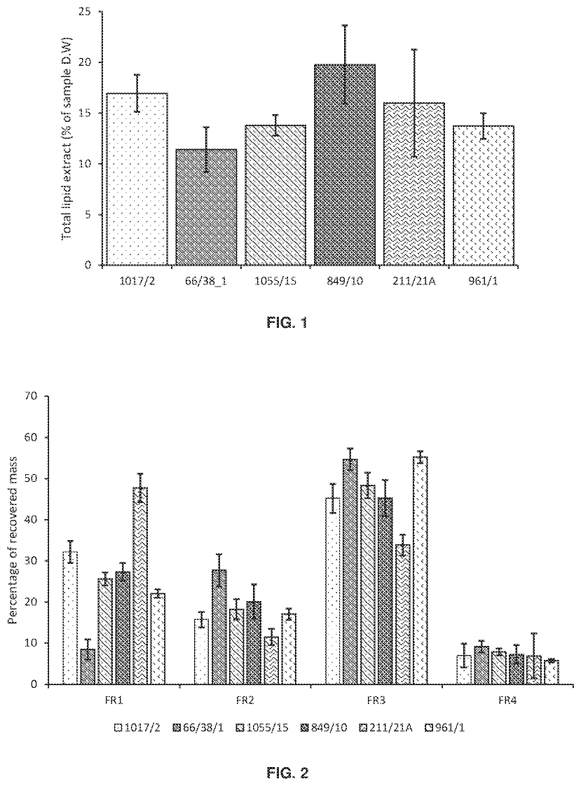

The total lipid content extracted from each of the microalgae are shown in FIG. 1. Each of N. oceanica and C. fusiformis had among the highest % total lipid extract (TLE). FIG. 2 shows the proportion of lipid in each of the four fractions from the recovered mass after SPE fractionation. Total recovery of the lipids after fractionation, determined by gravimetric analysis, ranged from about 80-95%.

Lipid Class Analysis of TLE

Phospholipid proportion varied from 10.73-18.37% (P. tricornutum and C. vulgaris respectively) of the TLE. Glycolipid proportions ranged from 17.23%- 25.65% (C. vulgaris and C. carterae respectively) of the TLE. The amount of neutral lipids in the TLE were the highest between 48.07% (N. oceanica) and 58.9% (C. vulgaris) of the TLE.

Lipid Class Analysis of Fraction 1

For all species, fraction 1 consisted entirely of neutral lipids, which was evident from the physical appearance of this fraction. Specifically, fraction 1 was a triacylglycerol (TAG)-rich liquid oil at room temperature.

Lipid Class Analysis of Fraction 2

Fraction 2 for all species consisted of a mixture of neutral lipids, sterols and pigment. All species had a neutral lipid content of 71.89-78.48% (N. oceanica and C. carterae respectively) apart from C. vulgaris with 59.97% neutral lipid. Sterol content varied from 11.44-17.19% in fraction 2. All species had between 8.86-10.91% pigment, except C. vulgaris which had over double the quantity (26.67%).

Lipid Class Analysis of Fraction 3—Glycolipid-Rich Extract

Fraction 3 consisted of primarily glycolipids (41.6-61.59%), phospholipids (7.45-20.87%), pigment (14.56-30.35%) and neutral lipids (4.31-9.59%). The exception was C. vulgaris which consisted of primarily glycolipid (66.83%), but pigment was the second highest values recorded (18.96%) and 14.2% phospholipid. This species had no neutral lipid in this fraction.

Lipid Class Analysis of Fraction 4—Phospholipid-Rich Extract

Generally, fraction 4 was comprised of phospholipids (42.76-56.72%), glycolipids (20.02-42.17%), pigments (10.09-14.5%) and neutral lipids (4.98-9.55%). For C. fusiformis and C. vulgaris Fraction 4 was composed of primarily phospholipids (67.1% and 56.58% respectively), glycolipids (23.41% and 31.67% respectively) and pigments (7.03% and 11.55% respectively).

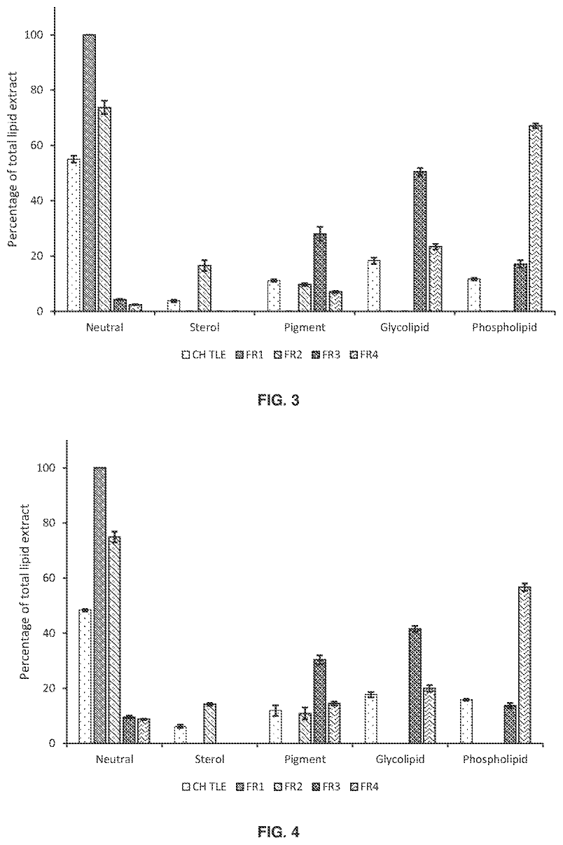

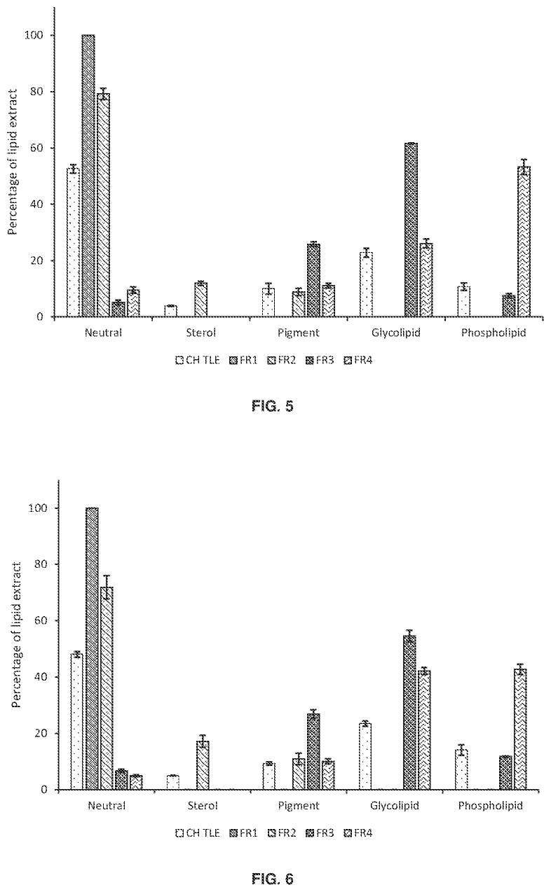

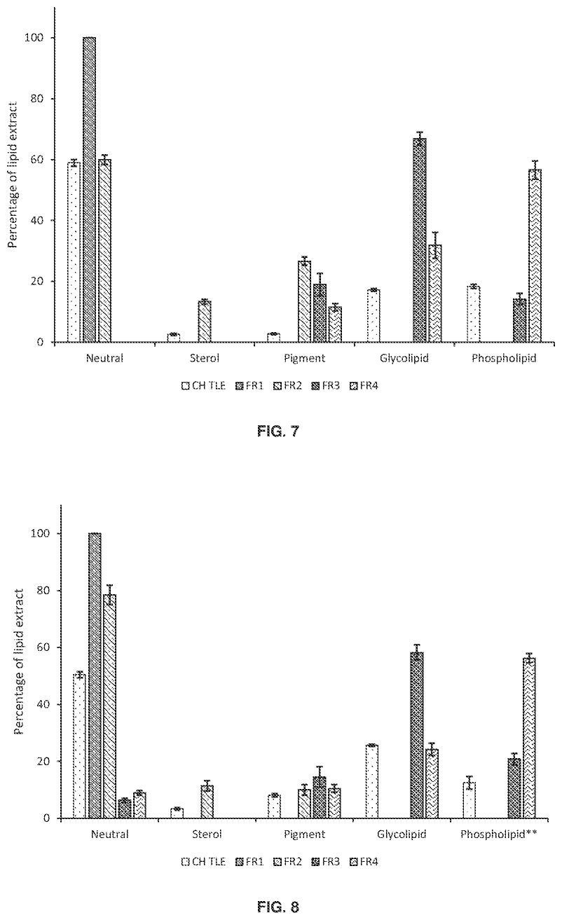

FIGS. 3-8 show the lipid class profiles for each of the microalgae in the TLE (CH TLE), as well as in each of the four lipid fractions (FR1-3). The amounts of glycolipids and phospholipids in each of the TLE, fraction 3, and fraction 4 are also provided in Table 2, below.

TABLE 2
Amounts of Glycolipid and Phospholipid in the TLE and Fractions 3 and 4

| | | C. vulgaris | P. tricornutum | N. oceanica | C. fusiformis | T. suecica | C. carterae |
|---|---|---|---|---|---|---|---|
| | | CCAP | CCAP | CCAP | CCAP | CCAP | CCAP |
| Microalgae | | 211/21A | 1055/15 | 849/10 | 1017/2 | 66/38_1 | 961/1 |
| % lipid extracted | | 15.98 | 13.79 | 19.77 | 16.93 | 11.39 | 13.71 |
| % of | Phospholipid | 18.37 | 10.73 | 14.1 | 11.68 | 15.85 | 12.5 |
| TLE | Glycolipid | 17.23 | 22.84 | 23.51 | 18.32 | 17.67 | 25.65 |
| % of | Phospholipid | 14.2 | 7.45 | 11.74 | 14.13 | 13.75 | 20.87 |
| Fraction 3 | Glycolipid | 66.83 | 61.6 | 54.6 | 50.5 | 41.6 | 58.21 |
| % of | Phospholipid | 56.58 | 53.29 | 42.76 | 67.1 | 56.72 | 56.24 |
| Fraction 4 | Glycolipid | 31.87 | 26.06 | 42.17 | 23.41 | 20.02 | 24.21 |

### Example 3: Chocolate Formation with Microalgal Extracts

Materials. Chemicals used were of HPLC grade, obtained from Sigma-Aldrich (Dorset, UK) with potassium chloride obtained from Fisher Scientific (Loughborough). High performance thin layer chromatography (HPTLC) silica plates, TLC silica plates, Supelco 37 FAME mix, dimethyloxazoline (DMOX) and butylated hydroxytoluene (BHT) were obtained from Sigma Aldrich (Dorset, UK). Chocolate crumb, commercial soy lecithin (SL) and commercial PGPR were obtained from Mars Wrigley Confectionary (UK), and sunflower oil was obtained from a local supermarket.

Preparation of Chocolate Mixes. The remainder of the extracts that were pooled according to fraction number and species as described in Example 2 were used for incorporation into two chocolate test mixes.

Dry TLE (from all six species) and fractions 3 and 4 of selected microalgae species (P. tricornutum CCAP 1055/15, N. oceanica CCAP 849/10 and C. vulgaris CCAP 211/21A) were incorporated into two chocolate test mixes. For all experiments the same batch of all of these ingredients was used. Standard test mixes were formulated as provided in Table 3, below.

TABLE 3
Chocolate Text Mix Formulations

| Mix | Component | Mass (g) |
|---|---|---|
| Standard Mix 1 (SM1) | Chocolate Crumb | 7.2 |
| | Sunflower oil | 2.717 |
| | Soy lecithin (total) | 0.083 |
| Standard Mix 2 (SM2) | Chocolate Crumb | 7.2 |
| | Sunflower oil | 2.717 |
| | Soy lecithin (total) | 0.063 |
| | PGPR | 0.02 |

Sunflower oil (SFO) and SL were combined in the appropriate ratio (163.77:1 w/w) and sonicated for 20 minutes. A sample tube was prepared with 2.7336 g of the SFO/SL mix and 7.2 g of chocolate crumb. The sample was vortexed with sequential “scraping down” of the sides of the tube to ensure all dry material was incorporated. This was continued as the crumb aggregated into small balls. After some time the balls formed a single mass in the tube, solid to the touch. The sample was homogenised using an Ultra Turrax (IKA T10 basic, IKA, Germany) until a solid deformable paste was achieved. This required sequential steps of vortexing and homogenizing.

Using a syringe, 0.0664 g of SL was added (SM1) or 0.0464 g of SL and 0.02 g PGPR (SM2). The sample was subjected to sequential steps of vortexing and homogenising until the viscosity of the sample had decreased substantially.

For microalgae lipid extracts, the standard mixes were prepared as described above, with microalgae lipid extract completely replacing SL in SM1 and replacing the PGPR in SM2. However, for SM1 it was not possible to premix with a volume of SFO due to the small quantities of extract available for testing. Therefore, 0.0166 g of microalgae extract was combined with 2.717 g SFO and 7.2 g of crumb before proceeding as above.

All samples were then stored at RT overnight and processed for rheology approximately 24 hours after formulation. Microalgae lipid test mix samples were then photographed after rheology testing to visually assess color and effectiveness of incorporation.

Visual Inspection. Visual inspection revealed the samples to have a consistent color. The TLEs exhibited the improved incorporation into the chocolate test mixes, as compared to fraction 3 and fraction 4, as indicated by the minimal sign of the pigmented inclusions. All of the extracts exhibited discoloration with a greenish-brown color cast. For all species this discoloration was less noticeable in SM2 due to the lower masses of extract incorporated into this test mix (0.02 g vs. 0.083 g).

Rheology. The rheology of chocolate standard mixes and microalgae lipid extract test mixes was characterized using a parallel plate rheometer (AR2000, TA Instruments, UK) equipped with a Peltier plate (set at 20° C.) and stainless steel cross-hatched 40 mm flat plate geometry (part no. 517400.901). The samples were tested in three batches, one batch testing the TLE from the six microalgae species, one batch with the phospholipid enriched extracts (fraction 4) from selected species and one batch with the glycolipids (fraction 3) from selected species. Chocolate standard mixes were also produced per batch for comparison. Samples were run over a variety of shear stresses until the sample exhibited fracture. The data used to construct the shear stress vs. viscosity figures were obtained from the last successful run immediately preceding a run where fracture occurred or where it looked likely that fracture was close to occurring.

The yield stress (YS) was determined as the lowest shear stress value obtained and the HSV as the lowest viscosity obtained before fracture of the sample occurred. In order to better compare results between the three batches (TLE, PL, GLY) the YS and HSV values were normalized by converting them to a percentage difference from the relevant standard mix.

Chocolate Standard Mixes

Rheology of the chocolate standard mixes for each of SM1 and SM2 revealed variability in yield stress (YS) values of from 62.26 Pa to 118.81 Pa for SM1 and from 25.89 Pa to 54.38 Pa for SM2, which was roughly correlated with increasing age of ingredients. High shear viscosity (HSV) values varied over the three batches. The HSV of SM1 varied from 13.41 Pa to 17.17 Pa, and the HSV of SM2 varied from 10.84 Pa to 16.85 Pa. Without intending to be bound by theory, the variance in YS and HSV of the chocolate standard mixes indicated the instability of the ingredients, particularly with the crumb having a more ‘clumpy’ texture over time. This suggested that the crumb was taking up appreciable levels of moisture from the surrounding atmosphere despite being stored in a sealed bag between batch preparation. The instability of the ingredients may have played a role in the increasing variability between replicates over the batches.

Microalgae TLE in SM1

SM1 formulated with TLE exhibited lower differences in HSV (from 11.6% to 52.46% difference) and larger differences in YS compared to chocolate SM1. Samples formulated with C. fusiformis CCAP 1017/2, T. suecica CCAP 66/38_1 and P. tricornutum CCAP 1055/15 TLE had very high YS differences compared to the chocolate SM1, varying between 84.82% and 122.56% different. The samples formulated with the three remaining species had a lower YS percent difference compared to the chocolate SM1, varying from 28.38% to 37.94% different. Significantly, C. vulgaris CCAP 211/21A and C. carterae CCAP 961/1 exhibited less variability than the chocolate SM1 in both YS and HSV, which suggested that these two extracts may have had improved incorporation into the text mixtures. Similarly, N. oceanica CCAP 849/10 achieved the least percentage difference from chocolate SM1.

Glycolipid-rich Extract (GLY; Fraction 3) in SM1

GLY-rich extracts were particularly effective at reducing YS. In particular, N. oceanica CCAP 849/10 reduced YS beyond that achieved by the best TLE sample and C. vulgaris CCAP 211/21A reduced YS to beyond that achieved by the chocolate SM1. P. tricomutum CCAP 1055/15 was the poorest performer, with a reduction in YS (41.9% diff.) comparable to the higher range of the best performing group of TLE, but with a percentage difference of HSV of 202.73% compared to the 11.6% to 52.46% difference for the entire TLE group. However, none of the GLY extracts reduced HSV to levels observed with the TLE mixes.

Phospholipid-Rich Extract (PL; Fraction 4) in SM1

The PL extracts were intermediate performers, as compared to the TLE and GLY extracts. Other than P. tricomutum CCAP 1055/15, differences in HSV (ranging from 18% to 21.35% diff) were less than GLY batch, and comparable to those achieved by TLE extracts. Differences in YS values were also comparable to those achieved by the TLE extracts (ranging from 40.08 to 57.73% diff).

Microalgae TLE in SM2

Differences in HSV for the TLE samples ranged from 17.67% to 42.39%, as compared to chocolate SM2, which were comparable to results seen for TLE SM1. Differences in YS varied from 171.15% to 368.13%, far higher than values seen with TLE SM1. Similar to SM1, N. oceanica CCAP 849/10 and C. vulgaris CCAP 211/21A performed best, but were still highly different compared to the TLE SM1.

Glycolipid-Rich Extract (GLY; Fraction 3) in SM2

GLY-rich extracts performed the best with HSV values close to those seen by the chocolate SM2 (ranging from −0.15% to 8.87% diff.) and YS values of 34.59-50.92% difference. Additionally, in most cases GLY-rich SM2 test samples had much lower variation between replicates. C. vulgaris CCAP 211/21A and P. tricomutum CCAP 1055/15 achieved extremely similar results and were the best of the three extracts tested, although all three performed comparably.

Phospholipid-Rich Extract (PL; Fraction 4) in SM2

The PL extracts were intermediate performers, performing better than TLE based on differences in YS (from 125.94% to 138.26% difference), but among the weakest performers for difference in HSV (34.08% to 252.83% difference). P. tricomutum CCAP 1055/15 performed particularly poorly based on HSV.

The data of Example 3 suggested that the amount of glycolipid in the extract was related to the improvement of the yield stress of the chocolate mixes. That is, it was observed for the TLE extracts from P. tricomutum, N. oceanica and C. vulgaris, which included between about 7.21% to 15.73% more glycolipid than soy lecithin, that the yield stress tended to decrease as compared to soy lecithin. Tables 4 and 5, below, show the relative differences in the amounts of lipids in each of the TLE and GLY/PL-rich extracts, respectively, as compared to soy lecithin.

TABLE 4
Differences in TLE lipid class composition compared to SL lipid class composition

| | C. fusiformis | T. suecica | P. tricornutum | N. oceanica | C. vulgaris | C. carterae |
|---|---|---|---|---|---|---|
| | CCAP | CCAP | CCAP | CCAP | CCAP | CCAP |
| Lipid Class | 1017/2 | 66/38_1 | 1055/15 | 849/10 | 211/21A | 961/1 |
| Neutral | 6.8835 | 0.1711 | 4.4048 | −0.0954 | 10.7423 | 2.2618 |
| Sterol | 0.0344 | 2.4136 | 0.0977 | 1.2272 | −1.1095 | −0.4640 |
| Pigment | 5.7714 | 6.5809 | 4.6201 | 3.9458 | −2.5438 | 2.7391 |
| Glycolipid | 8.4002 | 7.7563 | 12.9186 | 13.5959 | 7.3090 | 15.7311 |
| Phospholipid | −21.0895 | −16.9219 | −22.0412 | −18.6735 | −14.3981 | −20.2680 |

Table 4 shows that the TLE of all microalgae included substantially more glycolipid and substantially less phospholipid as compared to soy lecithin.

TABLE 5
Differences in selected GLY-rich and PL-rich fractions lipid
class composition compared to SL lipid class composition

| GLY-rich Extract (Fraction 3) | | | | PL-rich Extract (Fraction 4) | | |
|---|---|---|---|---|---|---|
| | P. tricornutum | N. oceanica | C. vulgaris | P. tricornutum | N. oceanica | C. vulgaris |
| | CCAP | CCAP | CCAP | CCAP | CCAP | CCAP |
| Lipid Class | 1055/15 | 849/10 | 211/21A | 1055/15 | 849/10 | 211/21A |
| Neutral | −43.0352 | −41.3986 | −48.1617 | −38.6136 | −43.1861 | −48.1617 |
| Sterol | −3.7843 | −3.7843 | −3.7843 | −3.7843 | −3.7843 | −3.7843 |
| Pigment | 20.4595 | 21.5282 | 13.5958 | 5.7302 | 4.7253 | 6.1863 |
| Glycolipid | 51.6748 | 44.6826 | 56.9166 | 16.1424 | 32.2548 | 21.9507 |
| Phospholipid | −25.3147 | −21.0280 | −18.5663 | 20.5254 | 9.9903 | 23.8091 |

Significantly, the highest level of glycolipid of the glycolipid-rich fractions, that is, for C. vulgaris, was the extract that exhibited the lowest yield stress—even lower than the chocolate sample mix with soy lecithin. However, the data suggest glycolipid content is not solely responsible for the reduction in YS activity, as P. tricornutum had a higher proportion of GLY compared to N. oceanica but did not perform better in either YS or HSV studies. Therefore, these data suggest there is a synergistic response between the amount of PL and GLY in the extracts.

Overall, Example 3 demonstrates that TLE extracts from N. oceanica CCAP 849/10, C. vulgaris CCAP 211/21A and C. carterae CCAP 961/1 were closest to SL in terms of rheology. Interestingly GLY-rich extracts from N. oceanica CCAP 849/10 and C. vulgaris CCAP 211/21A seemed particularly effective at reducing yield stress and, in addition to P. tricornutum CCAP 1055/15 GLY, also yielded favorable results for PGPR replacement.

What is claimed is:

1. A food composition comprising a microalgal extract, wherein
the microalgal extract comprises:
a glycolipid in an amount of about 15 to 70 wt %, based on the total weight of the extract; and,
a phospholipid in an amount of about 5 to 70 wt %, based on the total weight of the extract.

2. The food composition of claim 1, wherein the microalgal extract is derived from a marine microalgae.

3. The food composition of claim 2, wherein the marine microalgae is selected from the group consisting of Chlorella, Phaeodactylum, Nannochloropsis, Cylindrotheca, Tetraselmis, Crysotila, and mixtures thereof.

4. The food composition of claim 2, wherein the marine microalgae comprises Phaeodactylum tricornutum, Nannochloropsis oceanica, Chlorella vulgaris, Cylindrotheca fusiformis, Tetraselmis suecica, Crysotila carterae, or a mixture thereof.

5. The food composition of claim 1, wherein the microalgal extract comprises
a glycolipid in an amount of about 15 to 30 wt %, based on the total weight of the extract; and,
a phospholipid in an amount of about 10 to 20 wt %, based on the total weight of the extract.

6. The food composition of claim 1, wherein the microalgal extract comprises
a glycolipid in an amount of about 40 to 70 wt %, based on the total weight of the extract; and,
a phospholipid in an amount of about 5 to 25 wt %, based on the total weight of the extract.

7. The food composition of claim 1, wherein the microalgal extract comprises
a glycolipid in an amount of about 20 to 45 wt %, based on the total weight of the extract; and,
a phospholipid in an amount of about 40 to 70 wt %, based on the total weight of the extract.

8. The food composition of claim 1, wherein the microalgal extract is present in an amount of about 0.05 wt % to 2.0 wt %, based on the total weight of the food composition.

9. The food composition of claim 1, wherein the composition is substantially free of soy lecithin.

10. The food composition of claim 1, wherein the composition is substantially free of polyglycerol polyricinoleate (PGPR).

11. The food composition of claim 1, wherein the composition exhibits a maximum yield stress of about 200 Pa.

12. The food composition of claim 1, wherein the composition exhibits a maximum high shear viscosity of about 50 Pa.

13. The food composition of claim 1, wherein the microalgal extract comprises a glycolipid to phospholipid ratio ranging from about 1:3 to about 9:1.

14. The food composition of claim 1, selected from the group consisting of a snack food product, a baby food, a pet food, an animal feed, a bakery product, a dairy product, a meal replacement product, a ready meal, a soup, a pasta, a noodle, a canned food, a frozen food, a dried food, a chilled food, an oil, a margarine, a fat, a spread, a confectionery, and mixtures thereof.

15. The food composition of claim 14, wherein the food composition is a fat-based confectionery.

16. The food composition of claim 15, wherein the food composition is chocolate and further comprises at least one of cocoa solids, cocoa butter, sugar, milk powder, milk solids, and caramel.

17. The food composition of claim 14, wherein the food composition is a non-fat-based confectionery.

18. The food composition of claim 17, wherein the non-fat-based confectionary is selected from the group consisting of a compressed mint, a cotton candy, a frozen confection, a liquorice, a chewing gum, a gelled candy, a tableted candy, a hard candy, a chewy candy, and a combination thereof.

19. The food composition of claim 14 wherein the food composition is a confectionery selected from the group consisting of chocolate, cotton candy, pudding, fudge, toffee, gum, gelled candy, tableted candy, hard candy, chewy candy, and a combination thereof.

20. A method of preparing a microalgal extract for use in a food composition, comprising:
admixing a microalgae with an aqueous solution to provide a microalgal extraction mixture;
extracting a lipid-rich extract from the microalgal extraction mixture; and,
adding the lipid-rich extract to the food composition.

21. A method of preparing a microalgal extract for use in a food composition, comprising:
admixing a microalgae with an aqueous solution to provide a microalgal extraction mixture;
extracting a lipid-rich extract from the microalgal extraction mixture;
fractionating the lipid-rich extract to provide a glycolipid-rich extract and/or a phospholipid-rich extract; and
adding the glycolipid-rich extract and/or the phospholipid-rich extract to the food composition.

22. The method of claim 20, wherein the aqueous solution comprises an aqueous salt solution and methanol.

23. The method of claim 22, wherein the aqueous salt solution comprises KCl.

24. The method of claim 21, wherein the glycolipid-rich extract is added to the food composition.

25. The method of claim 21, wherein the phospholipid-rich extract is added to the food composition.
